(19) United States
(12) Patent Application Publication
(10) Pub. No.: US 2020/0077237 A1
(43) Pub. Date: Mar. 5, 2020

(54) MESSAGING FOR INFRASTRUCTURE PARAMETER MODIFICATION IN WIRELESS SYSTEMS

(71) Applicant: QUALCOMM Incorporated, San Diego, CA (US)

(72) Inventors: Prajwal Upadhya, San Jose, CA (US); Sushant Ashok Patil, San Jose, CA (US); Venkata Narendra Reddy Janga, San Jose, CA (US)

(21) Appl. No.: 16/556,069

(22) Filed: Aug. 29, 2019

Related U.S. Application Data
(60) Provisional application No. 62/726,607, filed on Sep. 4, 2018.

(51) Int. Cl. H04W 4/40; H04W 72/00; H04W 4/06; H04W 8/22

(52) U.S. Cl. CPC H04W 4/40; H04W 8/22; H04W 4/06; H04W 72/005

(57) ABSTRACT

Methods, systems, and devices for wireless communications are described. Incoming messages may be used to modify the state (e.g., the power state or operating state) of an infrastructure device such as street lights, traffic lights, residential lights, etc. Such incoming messages may be sent from vehicles, cell phones carried by pedestrians, or other devices (e.g., drones). To detect such devices or vehicles, the infrastructure device may monitor and receive messages transmitted from the device or vehicles. After receipt, the infrastructure device may determine a device type and one or more other parameters (e.g., location, speed, direction), and based on this determination, the infrastructure device may modify its state.

### CROSS REFERENCE

The present Application for Patent claims the benefit of U.S. Provisional Patent Application No. 62/726,607 by Upadhya et al., entitled “Altering The Power or Running State of Any CV2X Infrastructure Device Based on the Incoming CV2X Message,” filed Sep. 4, 2018, assigned to the assignee hereof, and expressly incorporated herein.

### BACKGROUND

The following relates generally to altering the power or the running states of cellular vehicle-to-everything (C-V2X) infrastructure devices.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal FDMA (OFDMA) systems. A wireless multiple-access communications system may include a number of base stations, each simultaneously supporting communication for multiple communication devices, which may be otherwise known as user equipment (UE).

### SUMMARY

A method of wireless communications implemented by an infrastructure device in a cellular vehicle-to-everything (C-V2X) wireless communications system is described. The method may include receiving a C-V2X message from a UE in the C-V2X wireless communications system, determining a device type of the UE and one or more parameters of the UE based on the C-V2X message from the UE, where the one or more parameters includes a velocity of the UE, a location of the UE, a direction of the UE at a given time, or any combination thereof, and modifying a state of the infrastructure device based on the device type of the UE and the one or more parameters of the UE.

An apparatus for wireless communications implemented by an infrastructure device in a C-V2X wireless communications system is described. The apparatus may include a processor, memory coupled with the processor, and instructions stored in the memory. The instructions may be executable by the processor to cause the apparatus to receive a C-V2X message from a UE in the C-V2X wireless communications system, determine a device type of the UE and one or more parameters of the UE based on the C-V2X message from the UE, where the one or more parameters includes a velocity of the UE, a location of the UE, a direction of the UE at a given time, or any combination thereof, and modify a state of the infrastructure device based on the device type of the UE and the one or more parameters of the UE.

Another apparatus for wireless communications implemented by an infrastructure device in a C-V2X wireless communications system is described. The apparatus may include means for receiving a C-V2X message from a UE in the C-V2X wireless communications system, determining a device type of the UE and one or more parameters of the UE based on the C-V2X message from the UE, where the one or more parameters includes a velocity of the UE, a location of the UE, a direction of the UE at a given time, or any combination thereof, and modifying a state of the infrastructure device based on the device type of the UE and the one or more parameters of the UE.

A non-transitory computer-readable medium storing code for wireless communications implemented by an infrastructure device in a C-V2X wireless communications system is described. The code may include instructions executable by a processor to receive a C-V2X message from a UE in the C-V2X wireless communications system, determine a device type of the UE and one or more parameters of the UE based on the C-V2X message from the UE, where the one or more parameters includes a velocity of the UE, a location of the UE, a direction of the UE at a given time, or any combination thereof, and modify a state of the infrastructure device based on the device type of the UE and the one or more parameters of the UE.

In some examples of the method, apparatuses, and non-transitory computer-readable medium described herein, the modifying the state of the infrastructure device may include operations, features, means, or instructions for modifying a power state or an operating state of the infrastructure device.

Some examples of the method, apparatuses, and non-transitory computer-readable medium described herein may further include operations, features, means, or instructions for receiving, from the UE, a set of C-V2X messages including the C-V2X message within a time duration.

Some examples of the method, apparatuses, and non-transitory computer-readable medium described herein may further include operations, features, means, or instructions for monitoring for the C-V2X message from the UE and one or more cellular vehicle-to-person (C-V2P) messages or one or more cellular vehicle-to-infrastructure (C-V2I) messages.

Some examples of the method, apparatuses, and non-transitory computer-readable medium described herein may further include operations, features, means, or instructions for receiving a second C-V2X message from the UE subsequent to receiving the C-V2X message from the UE, and determining the direction of the UE based on the C-V2X message and the second C-V2X message.

In some examples of the method, apparatuses, and non-transitory computer-readable medium described herein, the receiving the C-V2X message may include operations, features, means, or instructions for receiving a broadcast beacon carrying the C-V2X message over a set of broadcast resources, where the set of broadcast resources may be allocated periodically for the broadcast beacon.

In some examples of the method, apparatuses, and non-transitory computer-readable medium described herein, the receiving the C-V2X message may include operations, features, means, or instructions for receiving a coded discovery message indicating the C-V2X message over a sidelink communications channel.

Some examples of the method, apparatuses, and non-transitory computer-readable medium described herein may further include operations, features, means, or instructions for monitoring for one or more additional C-V2X messages from the UE for a threshold time duration, and modifying the state of the infrastructure device to a default state based on an absence of the one or more additional C-V2X messages from the UE during the monitoring for the threshold time duration.

In some examples of the method, apparatuses, and non-transitory computer-readable medium described herein, the modifying the state of the infrastructure device may include operations, features, means, or instructions for applying a policy associated with the C-V2X message to alter a power state of the infrastructure device.

In some examples of the method, apparatuses, and non-transitory computer-readable medium described herein, the policy may be applied during a timeout period for the infrastructure device.

Some examples of the method, apparatuses, and non-transitory computer-readable medium described herein may further include operations, features, means, or instructions for performing at least one action during the timeout period based on the policy.

Some examples of the method, apparatuses, and non-transitory computer-readable medium described herein may further include operations, features, means, or instructions for performing at least one revert action after performing the at least one action, where the revert action includes modifying a color or an intensity of a traffic light.

In some examples of the method, apparatuses, and non-transitory computer-readable medium described herein, the infrastructure device includes a street light, a traffic light, a residential light, or any combination thereof.

In some examples of the method, apparatuses, and non-transitory computer-readable medium described herein, the UE may be located on or within a vehicle of the C-V2X wireless communications system.

### BRIEF DESCRIPTION OF THE DRAWINGS

FIG. 1 is a block diagram illustrating an example wireless communications system in accordance with aspects of the present disclosure.

FIG. 2 is a block diagram illustrating an example logical architecture of a distributed radio access network (RAN) in accordance with aspects of the present disclosure.

FIG. 3 is a diagram illustrating an example physical architecture of a distributed RAN in accordance with aspects of the present disclosure.

FIG. 4 is a block diagram illustrating an example base station and user equipment (UE) in accordance with aspects of the present disclosure.

FIG. 5A is a diagram illustrating an example of a downlink-centric subframe according to aspects of the present disclosure.

FIG. 5B is a diagram illustrating an example of an uplink-centric subframe according to aspects of the present disclosure.

FIG. 6 is a flowchart of a method of altering the power or running state of a cellular vehicle-to-everything (C-V2X) infrastructure device based on incoming C-V2X messages in accordance with aspects of the present disclosure.

FIGS. 7A and 7B are flowcharts of example methods of altering the power or running state of a C-V2X infrastructure device based on incoming C-V2X messages in accordance with aspects of the present disclosure.

FIG. 8 illustrates components that may be included within a base station in accordance with aspects of the present disclosure.

FIG. 9 illustrates components that may be included within a wireless communication device in accordance with aspects of the present disclosure.

### DETAILED DESCRIPTION

Some wireless communications system may support various waveforms and transmission techniques, such as cyclic prefix-orthogonal frequency division multiplexing (CP-OFDM) and discrete Fourier transform-Spread-orthogonal frequency division multiplexing (DFT-S-OFDM). Fifth generation (5G) or New Radio (NR) systems may support switching between CP-OFDM and DFT-S-OFDM on the uplink, as CP-OFDM may provide a spatial multiplexing benefit through multiple-input multiple-output (MIMO) communication techniques, and DFT-S-OFDM may provide link budget benefits. Other waveforms and access techniques may be supported. For instance, in a long term evolution (LTE) network, orthogonal frequency-division multiple access (OFDMA) communications signals may be used for downlink communications, while Single-Carrier Frequency-Division Multiple Access (SC-FDMA) communications signals may be used for uplink communications. Compared to an OFDMA scheme, a DFT-S-OFDM scheme spreads a plurality of data symbols (i.e., a data symbol sequence) over a frequency domain, which may help reduce the peak to average power ratio (PAPR) of a signal. In some cases, a DFT-S-OFDMA scheme may also be referred to as an SC-FDMA scheme.

Scalable numerology (e.g., scalable OFDM multi-tone numerology) may be supported by a wireless communications system. For example, some systems (e.g., LTE) may support a fixed OFDM numerology of 15 kilohertz (kHz) spacing between OFDM tones (which may be referred to as subcarriers) and carrier bandwidths up to 20 megahertz (MHz), while other systems (e.g., 5G) may utilize a scalable OFDM numerology to support diverse spectrum bands or types and various deployment models. In some aspects, 5G may be capable of operating in millimeter wave (mmW) frequency bands that have wider channel widths (e.g., hundreds of MHz) than the channel widths utilized in LTE. Further, OFDM subcarrier spacing may scale with the channel width, and the fast Fourier transform (FFT) size scales such that processing complexity does not unnecessarily increase for wider bandwidths. As described herein, numerology refers to various parameters of a wireless communications system such as subcarrier spacing, cyclic prefix, symbol length, FFT size, transmission time interval (TTI) duration, etc.

In 5G NR, cellular technologies have been expanded into the unlicensed spectrum, both as stand-alone systems and licensed-assisted access (LAA) systems. The unlicensed spectrum may occupy frequencies up to 60 GHz, which may be part of the mmW spectrum, and may provide additional capacity for communications. For instance, LTE Unlicensed (LTE-U) may support LTE communications in an unlicensed spectrum with an ‘anchor’ channel in licensed spectrum, which may allow for faster downloads for users. Further, LTE-U may share the unlicensed spectrum fairly with Wi-Fi and such coexistence is beneficial in the 5 GHz unlicensed band where Wi-Fi devices are in wide use. An LTE-U network, however, may cause interference via an existing co-channel Wi-Fi device. In such cases, choosing an operating channel to reduce (e.g., minimize) the interference caused to nearby Wi-Fi devices or networks is a goal for LTE-U devices. An LTE-U single carrier device may operate on the same channel as a Wi-Fi device if all available channels are occupied by Wi-Fi devices. To coordinate spectrum access between LTE-U and Wi-Fi, the energy across the intended frequency band (e.g., channel) is detected by a device. This energy detection (ED) mechanism informs the device of ongoing transmissions by other nodes over the frequency band. Based on this ED information, a device decides whether to utilize the channel for communications. In some aspects, Wi-Fi devices do not back off to LTE-U communications unless the interference level is above an ED threshold (e.g., −62 decibels relative to a milliwatt (dBm) over 20 MHz). Without proper coexistence mechanisms in place, LTE-U transmissions may cause undesirable interference on a Wi-Fi network and corresponding Wi-Fi transmissions.

LAA is another member of the unlicensed technology family. Like LTE-U, it also uses an anchor channel in licensed spectrum, but unlike LTE-U, LAA supports a “listen before talk” (LBT) functionality. A gating interval may be used to gain access to a channel of a shared or unlicensed spectrum. The gating interval may determine the application of a contention-based protocol such as an LBT protocol. For example, the gating interval may indicate when a Clear Channel Assessment (CCA) is performed. Whether a channel of the shared unlicensed spectrum is available or in use is determined by the CCA and if the channel is “clear” for use, i.e., available, the gating interval may allow the transmitting apparatus to use the channel. Access to the channel is typically for a predefined transmission interval. If the channel is not cleared for use, then a device will not transmit.

Another unlicensed technology is LTE-wireless local area network (WLAN) Aggregation (LWA) which utilizes both LTE and Wi-Fi. Accounting for both channel conditions, LWA splits a single data flow into two data flows which allows both an LTE channel and a Wi-Fi channel to be used for an application. Instead of competing with Wi-Fi, the LTE signal is using the WLAN connections seamlessly to increase capacity.

MulteFire is another example of unlicensed technology that supports LTE communications solely in unlicensed spectrum (e.g., in the 5 GHz spectrum band). Unlike LTE-U and LAA, MulteFire allows entities without any access to licensed spectrum and may operate in unlicensed spectrum on a standalone basis, that is, without any anchor channel in the licensed spectrum. MulteFire differs from LTE-U, LAA, and LWA because as MulteFire does not utilize an anchor in licensed spectrum. Without relying on licensed spectrum as the anchoring service, MulteFire allows for Wi-Fi like deployments. A MulteFire network may include access points (APs) or base stations communicating in an unlicensed radio frequency spectrum band without an licensed anchor carrier.

A discovery reference signal (DRS) Measurement Timing Configuration (DMTC) is a technique that allows MulteFire to transmit but with reduced (e.g., minimal) interference to other unlicensed technologies including Wi-Fi. Further, the periodicity of DRSs is sparse compared to other reference signals, which may allow MulteFire to access channels occasionally, transmit discovery and control signals, and vacate the channels thereafter. As the unlicensed spectrum is shared with other radios of similar or dissimilar wireless technologies, an LBT procedure may be used to sense a channel. LBT involves sensing the medium (e.g., a channel) for a given amount of time and backing off (e.g., refraining from transmitting) if the channel is busy. The initial random access procedure for standalone LTE-U may involve as few transmissions as possible and have low latency such that the number of LBT operations is reduced or minimized, allowing the random access procedure to be completed as quickly as possible.

Leveraging a DMTC window, MulteFire algorithms search and decode reference signals in an unlicensed band from neighboring base stations in order to determine which base station is to serve the UE. As the UE moves, the UE sends a measurement report to nearby base stations, which may trigger a handover from a serving base station to a target base station, transferring the UE (and associated content and information) to the target base station.

As LTE traditionally operates in licensed spectrum and Wi-Fi operates in unlicensed bands, coexistence with Wi-Fi or other unlicensed technology was not considered when LTE was initially designed. In moving to unlicensed, the LTE waveform was modified and algorithms were supported to perform LBT, which facilitates channel fairness. The present example supports LBT and the detection and transmission of Wi-Fi Channel Usage Beacon Signal (WCUBS) for ensuring coexistence with Wi-Fi neighbors.

MulteFire is capable of “hearing” a neighboring Wi-Fi transmission (e.g., because the neighboring Wi-Fi transmission is utilizing the unlicensed spectrum). In MulteFire, a device listens first, and determines whether to utilize an unlicensed channel when there are no other neighboring Wi-Fi devices on the same channel. This technique may provide coexistence between MulteFire and Wi-Fi. Some communications techniques adhere to the unlicensed rules and regulations set by governing bodies such as the 3rd Generation Partnership Project (3GPP) and the European Telecommunications Standards Institute (ETSI). Such bodies may mandate an LBT detection threshold (e.g., a −72 dBm LBT detection threshold), which may help to resolve conflict between MulteFire and Wi-Fi devices.

Additional functionality for 5G involves the use of spectrum sharing (e.g., NR Shared Spectrum (NR-SS)). Such techniques may provide enhancement, expansion, and upgraded spectrum sharing technologies introduced in LTE. These include LWA, LAA, enhanced LAA (eLAA), License Shared Access (LSA), and citizens broadband radio service (CBRS), among others.

Aspects of the disclosure are initially described in the context of a wireless communications system. Aspects of the disclosure are then illustrated by and described with reference to apparatus diagrams, system diagrams, and flowcharts that relate to parameter modification based on messaging in wireless systems.

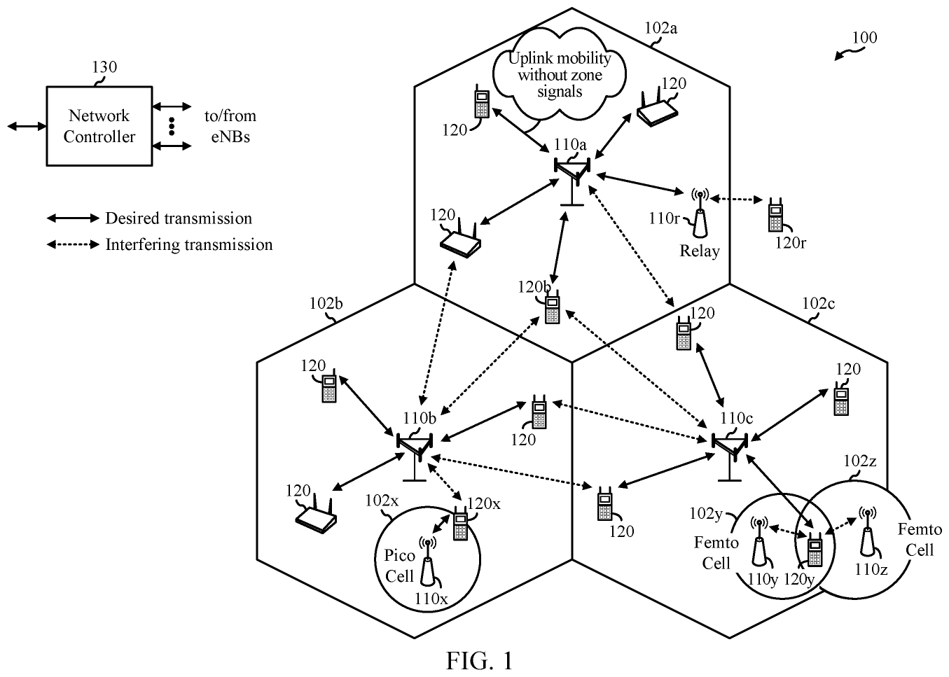

FIG. 1 illustrates an example wireless communications system 100, such as a 5G or NR network, in which aspects of the present disclosure may be supported or implemented. As illustrated in FIG. 1, the wireless communications system 100 may include a number of base stations 110 and other network entities. A base station 110 may be a station that communicates with one or more UEs 120. Each base station 110 may provide communication coverage for a particular geographic area (e.g., a cell 102). A cell 102 can refer to a coverage area of a NodeB or a NodeB subsystem serving this coverage area, depending on the context in which the term is used. In NR systems, the term cell 102 and eNB, NodeB, 5G NB, AP, NR base station, 5G Radio NodeB (gNB), or transmission reception point (TRP) may be interchangeable. In some aspects, a cell 102 may not necessarily be stationary, and the geographic area of the cell may move according to the location of a mobile base station 110. In some aspects, the base stations 110 may be interconnected to one another or to one or more other base stations 110 or network nodes (not shown) in the wireless communications system 100 through various types of backhaul interfaces such as a direct physical connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

A base station 110 may provide communication coverage for a macro cell 102, a pico cell 102, a femto cell 102, or other types of cell 102. A macro cell 102 may cover a relatively large geographic area (e.g., several kilometers (km) in radius) and may allow unrestricted access by UEs 120 with service subscription. A pico cell 102 may cover a relatively small geographic area and may allow unrestricted access by UEs 120 with service subscription. A femto cell 102 may cover a relatively small geographic area (e.g., a home) and may allow restricted access by UEs 120 having association with the femto cell 102 (e.g., UEs 120 in a Closed Subscriber Group (CSG), UEs 120 for users in the home, etc.). A base station 110 for a macro cell 102 may be referred to as a macro base station 110. A base station 110 for a pico cell 102 may be referred to as a pico base station 110. A base station 110 for a femto cell 102 may be referred to as a femto base station 110 or a home base station 110. In the example shown in FIG. 1, the base stations 110a, 110b, and 110c may be macro base stations 110 for the macro cells 102a, 102b, and 102c, respectively. The base station 110x may be a pico base station 110 for a pico cell 102x. The base stations 110y and 110z may be femto base station 110 for the femto cells 102y and 102z, respectively. A base station 110 may support one or multiple (e.g., three) cells 102.

The wireless communications system 100 may also include relay stations. A relay station is a station that receives a transmission of data or other information from an upstream station (e.g., a base station 110 or a UE 120) and sends a transmission of the data or other information to a downstream station (e.g., a UE 120 or a base station 110). A relay station may also be a UE 120 that relays transmissions for other UEs 120. In the example shown in FIG. 1, a relay station 110r may communicate with the base station 110a and a UE 120r in order to facilitate communication between the base station 110a and the UE 120r. A relay station may also be referred to as a relay base station 110, a relay, etc.

The wireless communications system 100 may be a heterogeneous network that includes base stations 110 of different types, e.g., macro base station 110, pico base station 110, femto base station 110, relays, etc. These different types of base stations 110 may have different transmit power levels, different coverage areas, and different impact on interference in the wireless communications system 100. For example, macro base station 110 may have a high transmit power level (e.g., 20 Watts) whereas pico base station 110, femto base station 110, and relays may have a lower transmit power level (e.g., 1 Watt).

The wireless communications system 100 may support synchronous or asynchronous operation. For synchronous operation, the base stations 110 may have similar frame timing, and transmissions from different base stations 110 may be approximately aligned in time. For asynchronous operation, the base stations 110 may have different frame timing, and transmissions from different base stations 110 may not be aligned in time. The techniques described herein may be used for both synchronous and asynchronous operation.

A network controller 130 may be coupled to a set of base stations 110 and provide coordination and control for these base stations 110. The network controller 130 may communicate with the base stations 110 via a backhaul. The base stations 110 may also communicate with one another, e.g., directly or indirectly via wireless or wireline backhaul.

The UEs 120 (120x, 120y, etc.) may be dispersed throughout the wireless communications system 100, and each UE 120 may be stationary or mobile. A UE 120 may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or medical equipment, a healthcare device, a biometric sensor/device, a wearable device such as a smart watch, smart clothing, smart glasses, virtual reality goggles, a smart wrist band, smart jewelry (e.g., a smart ring, a smart bracelet, etc.), an entertainment device (e.g., a music device, a video device, a satellite radio, etc.), a vehicular component or sensor, a smart meter/sensor, a robot, a drone, industrial manufacturing equipment, a positioning device (e.g., global positioning system (GPS), Beidou, terrestrial), or any other suitable device that is configured to communicate via a wireless or wired medium. Some UEs 120 may be considered machine-type communication (MTC) devices or evolved MTC (eMTC) devices, which may include remote devices that may communicate with a base station 110, another remote device, or some other entity. MTC may refer to communication involving at least one remote device on at least one end of the communication and may include forms of data communication which involve one or more entities that do not necessarily utilize human interaction. MTC UEs 120 may include UEs 120 that are capable of MTC communications with MTC servers or other MTC devices through Public Land Mobile Networks (PLMN), for example. MTC and eMTC UEs 120 include, for example, robots, drones, remote devices, sensors, meters, monitors, cameras, location tags, etc., that may communicate with a base station 110, another device (e.g., remote device), or some other entity. A wireless node may provide, for example, connectivity for or to a network (e.g., a wide area network such as Internet or a cellular network) via a wired or wireless communication link. MTC UEs 120, as well as other UEs 120, may be implemented as Internet-of-Things (IoT) devices, e.g., narrowband IoT (NB-IoT) devices. In NB IoT, the uplink and downlink have higher periodicities and repetitions interval values as a UE 120 decodes data in extended coverage.

In FIG. 1, a solid line with double arrows indicates desired transmissions between a UE 120 and a serving base station 110, which is a base station 110 designated to serve the UE 120 on the downlink or uplink. A dashed line with double arrows indicates interfering transmissions between a UE 120 and a base station 110.

Certain wireless networks (e.g., LTE) utilize OFDM on the downlink and SC-FDM on the uplink. OFDM and SC-FDM partition the system bandwidth into multiple (K) orthogonal subcarriers, which may be referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (which may be referred to as a resource block) may be 12 subcarriers (or 180 kHz). Consequently, the nominal FFT size may be equal to 128, 256, 512, 1024 or 2048 for system bandwidth of 1.25, 2.5, 5, 10 or 20 MHz, respectively. The system bandwidth may also be partitioned into subbands. For example, a subband may cover 1.08 MHz (e.g., 6 resource blocks), and there may be 1, 2, 4, 8 or 16 subbands for system bandwidth of 1.25, 2.5, 5, 10 or 20 MHz, respectively.

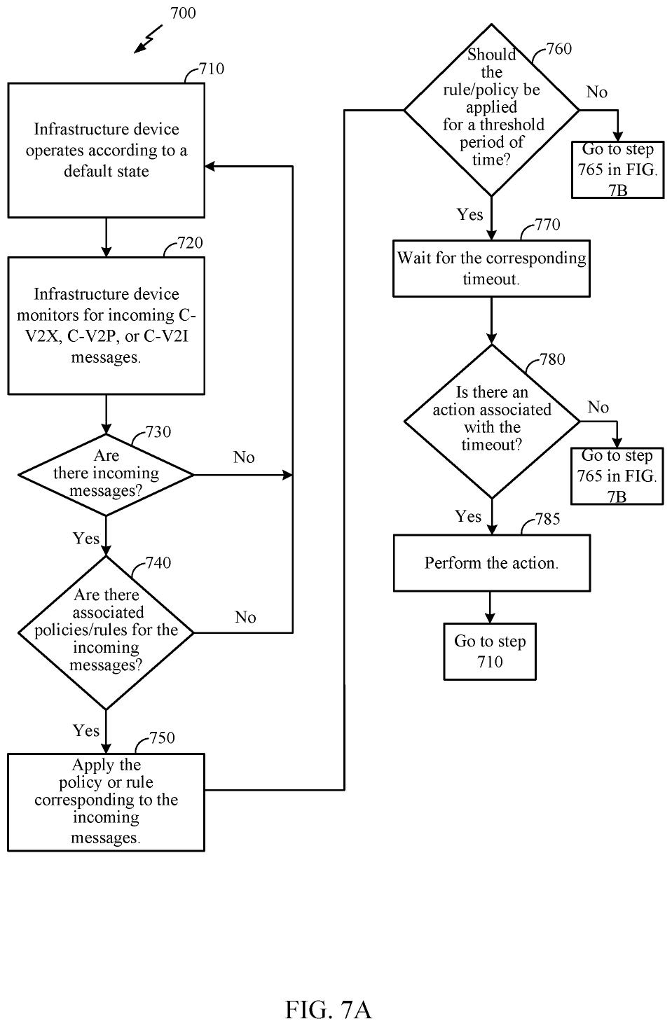

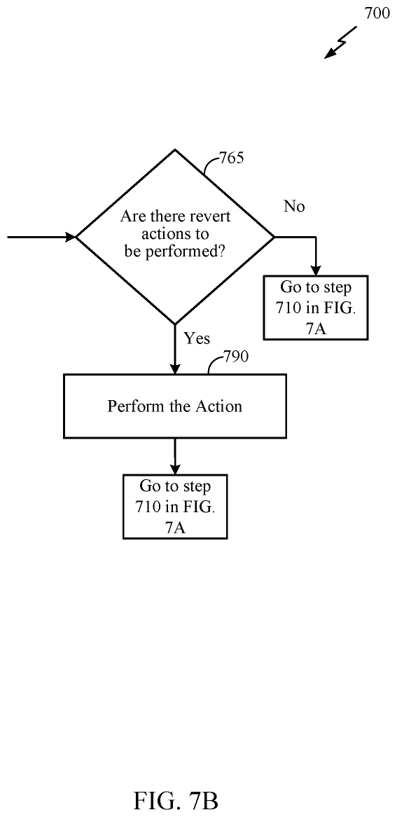

While aspects of the examples described herein may be associated with LTE technologies, aspects of the present disclosure may be applicable with other wireless communications systems, such as NR. NR may utilize OFDM with a CP on the uplink and downlink and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 ms duration. Each radio frame may consist of 50 subframes with a length of 10 ms. Consequently, each subframe may have a length of 0.2 ms. Each subframe may indicate a link direction (e.g., downlink or uplink) for data transmission and the link direction for each subframe may be dynamically switched. Each subframe may include downlink/uplink data as well as downlink/uplink control data. Uplink and downlink subframes for NR may be as described in more detail below with respect to FIGS. 6, 7A, and 7B.

Beamforming may be supported and beam direction may be dynamically configured. MIMO transmissions with precoding may also be supported. MIMO configurations in the downlink may support up to 8 transmit antennas with multi-layer downlink transmissions up to 8 streams and up to 2 streams per UE. Multi-layer transmissions with up to 2 streams per UE 120 may be supported. Aggregation of multiple cells may be supported with up to 8 serving cells. Alternatively, NR may support a different air interface, other than an OFDM-based. NR networks may include entities such central units (CUs) or distributed units (DUs) (e.g., in an integrated access and backhaul (IAB) system).

In some aspects, access to the air interface may be scheduled, where a scheduling entity (e.g., a base station 110) allocates resources for communication among some or all devices and equipment within its service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity. Base stations 110 are not the sole entities that may function as a scheduling entity. That is, in some aspects, a UE 120 may function as a scheduling entity, scheduling resources for one or more subordinate entities (e.g., one or more other UEs 120). In this example, the UE 120 is functioning as a scheduling entity, and other UEs 120 utilize resources scheduled by the UE 120 for wireless communication. A UE 120 may function as a scheduling entity in a peer-to-peer (P2P) network, or in a mesh network. In a mesh network example, UEs 120 may optionally communicate directly with one another in addition to communicating with the scheduling entity.

Thus, in wireless communications system 100 supporting scheduled access to time-frequency resources and having a cellular configuration, a P2P configuration, and a mesh configuration, a scheduling entity and one or more subordinate entities may communicate utilizing the scheduled resources.

As noted above, a RAN may include a CU and DUs. A NR base station (e.g., eNB, 5G NodeB, Node B, TRP, AP, or gNB) may correspond to one or multiple base stations. NR cells can be configured as access cell (ACells) or data only cells (DCells). For example, the RAN (e.g., a CU or DU) can configure the cells. DCells may be cells used for carrier aggregation or dual connectivity, but not used for initial access, cell selection, cell reselection, or handover. In some cases, DCells may not transmit synchronization signals, but in other cases, DCells may transmit synchronization signals. NR base stations 110 may transmit downlink signals to UEs 120 indicating the cell type. Based on the cell type indication, the UE 120 may communicate with the NR base station 110. For example, the UE 120 may determine NR base stations 110 to consider for cell selection, access, handover, or measurement based on the indicated cell type.

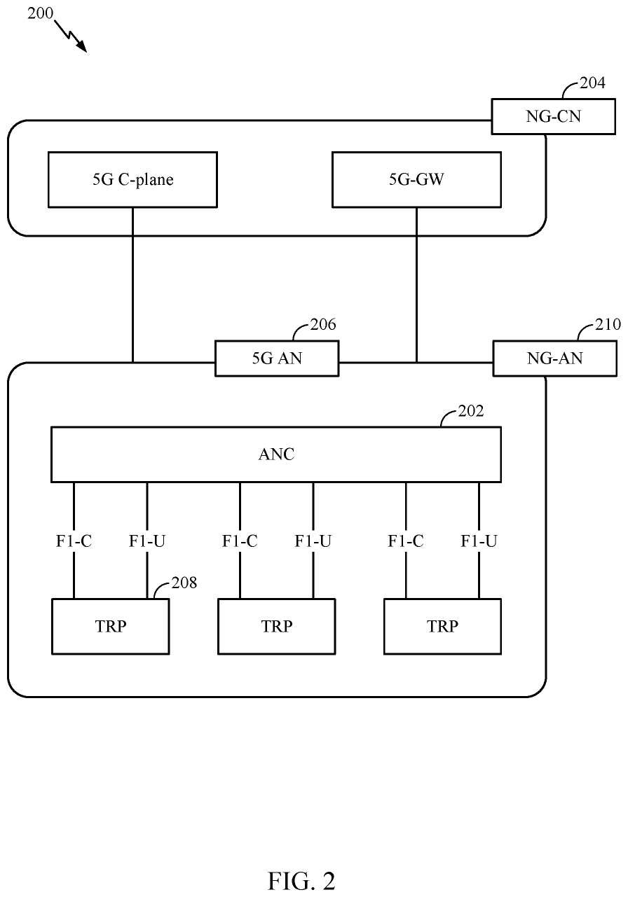

FIG. 2 illustrates an example logical architecture of a distributed RAN 200, which may be implemented in the wireless communications system illustrated in FIG. 1. A 5G access node (AN) 206 may include an AN controller (ANC) 202. The ANC may be a CU of the distributed RAN 200. The backhaul interface to the next generation core network (NG-CN) 204 may terminate at the ANC 202. The backhaul interface to neighboring next generation access nodes (NG-ANs) 210 may terminate at the ANC 202. The ANC 202 may include one or more TRPs 208 (which may also be referred to as base stations, NR base stations, NodeBs, 5G NBs, APs, eNB, gNB, or some other term). As described herein, a TRP 208 may be used interchangeably with the term cell.

The TRPs 208 may each be a DU. The TRPs 208 may be connected to one ANC 202 or multiple ANCs (not illustrated). For example, for RAN sharing, radio as a service (RaaS), and service specific ANC deployments, the TRP 208 may be connected to more than one ANC 202. A TRP 208 may include one or more antenna ports. The TRPs 208 may be configured to individually (e.g., dynamic selection) or jointly (e.g., joint transmission) serve traffic to a UE (e.g., UE 120 of FIG. 1).

The distributed RAN 200 may be used to support fronthauling solutions across different deployment types. For example, the distributed RAN 200 may be based on transmit network capabilities (e.g., bandwidth, latency, or jitter). The distributed RAN 200 may share features or components with LTE. According to aspects, the NG-AN 210 may support dual connectivity with NR. The NG-AN 210 may share a common fronthaul for LTE and NR. The distributed RAN 200 may enable cooperation between and among TRPs 208. For example, cooperation may be preset within a TRP 208 or across TRPs 208 via the ANC 202. According to aspects, no inter-TRP interface may be present.

According to aspects, a dynamic configuration of split logical functions may be present within the distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU or CU (e.g., TRP 208 or ANC 202, respectively). According to some aspects, a base station may include a CU (e.g., ANC 202) or one or more DUs (e.g., one or more TRPs 208).

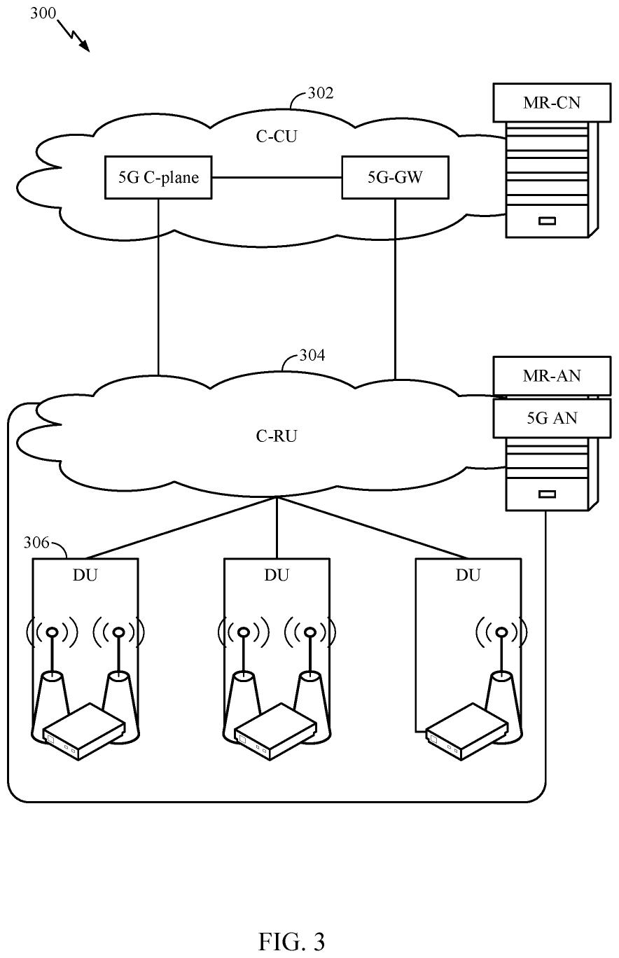

FIG. 3 illustrates an example physical architecture of a distributed RAN 300, according to aspects of the present disclosure. A centralized core network unit (C-CU) 302 may host core network functions. The C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment and in some aspects, the C-RU 304 may be closer to the network edge.

A DU 306 may host one or more TRPs (edge node (EN), an edge unit (EU), a radio head (RH), a smart RH (SRH), or the like). The DU 306 may be located at edges of the network with radio frequency functionality.

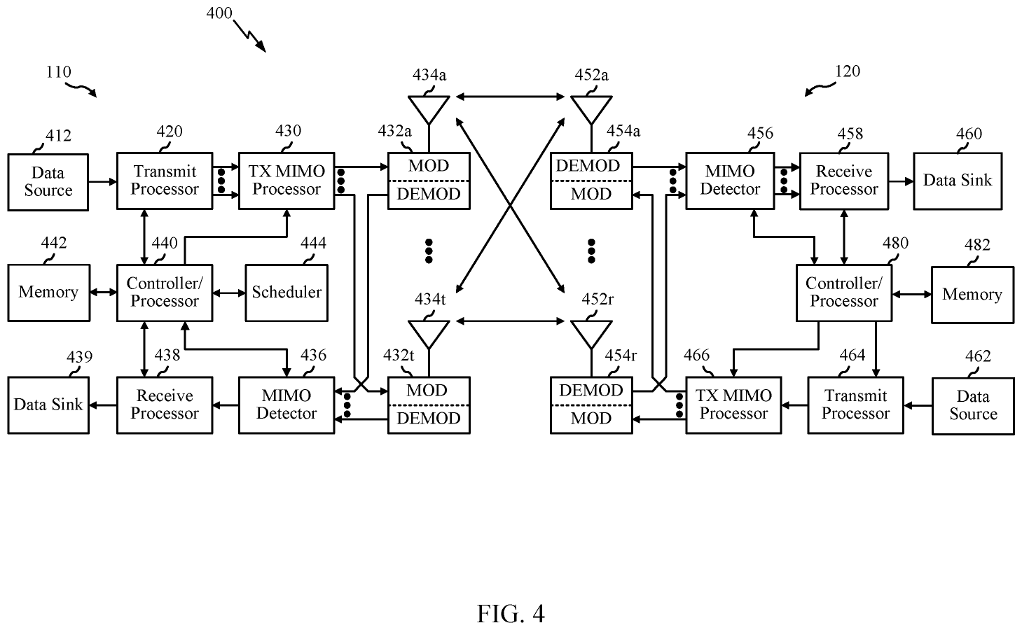

FIG. 4 illustrates example components of a base station 110 and a UE 120 illustrated in FIG. 1, which may be used to implement aspects of the present disclosure. As described herein, the base station 110 may include a TRP. One or more components of the base station 110 and UE 120 may be used to practice aspects of the present disclosure. For example, antennas 452, processors 466, 458, 464, or controller/processor 480 of the UE 120 or antennas 434, processors 460, 420, 438, or controller/processor 440 of the base station 110 may be used to perform the operations described herein.

FIG. 4 shows a block diagram of a design of a base station 110 and a UE 120, which may be one of the base stations and one of the UEs in FIG. 1. For a restricted association scenario, the base station 110 may be the macro base station 110c in FIG. 1, and the UE 120 may be the UE 120y. The base station 110 may also be a base station of some other type. The base station 110 may be equipped with antennas 434a through 434t, and the UE 120 may be equipped with antennas 452a through 452r.

At the base station 110, a transmit processor 420 may receive data from a data source 412 and control information from a controller/processor 440. The control information may be for the Physical Broadcast Channel (PBCH), Physical Control Format Indicator Channel (PCFICH), Physical Hybrid ARQ Indicator Channel (PHICH), Physical Downlink Control Channel (PDCCH), etc. The data may be for the Physical Downlink Shared Channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal. A transmit (TX) multiple-input multiple-output (MIMO) processor 430 may perform spatial processing (e.g., precoding) on the data symbols, the control symbols, or the reference symbols, if applicable, and may provide output symbol streams to the modulators (MODs) 432a through 432t. For example, the TX MIMO processor 430 may perform certain aspects described herein for reference signal multiplexing. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. For example, MIMO detector 456 may provide detected reference signal transmitted using techniques described herein. A receive processor 458 may process (e.g., demodulate, deinterleave, and decode) the detected symbols, provide decoded data for the UE 120 to a data sink 460, and provide decoded control information to a controller/processor 480. According to one or more cases, coordinated multi-point (CoMP) aspects can include providing the antennas, as well as some TX/RX functionalities, such that they reside in distributed units. For example, some TX/RX processing may be done in the CU, while other processing can be done at the DU. For example, in accordance with one or more aspects as shown in the diagram, the base station mod/demod 432 may be in the DUs.

On the uplink, at the UE 120, a transmit processor 464 may receive and process data (e.g., for the Physical Uplink Shared Channel (PUSCH)) from a data source 462 and control information (e.g., for the Physical Uplink Control Channel (PUCCH) from the controller/processor 480. The transmit processor 464 may also generate reference symbols for a reference signal. The symbols from the transmit processor 464 may be precoded by a TX MIMO processor 466 if applicable, further processed by the demodulators 454a through 454r (e.g., for SC-FDM, etc.), and transmitted to the base station 110. At the base station 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the base station 110 and the UE 120, respectively. The processor 440 or other processors and modules at the base station 110 may perform or direct the processes for the techniques described herein. The processor 480 or other processors and modules at the UE 120 may also perform or direct processes for the techniques described herein. The memories 442 and 482 may store data and program codes for the base station 110 and the UE 120, respectively. A scheduler 444 may schedule UEs for data transmission on the downlink or uplink.

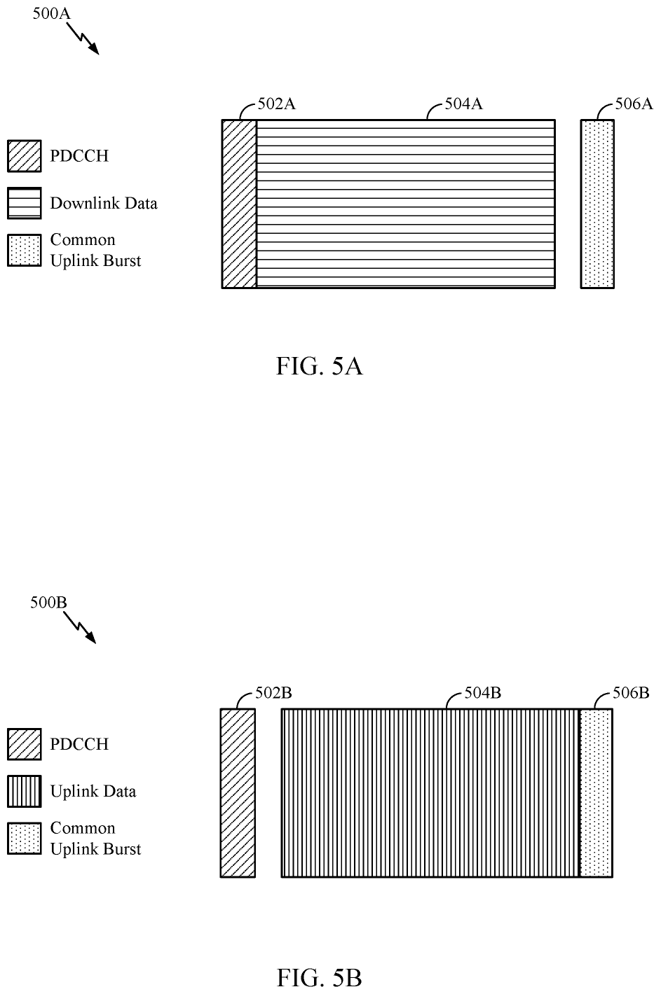

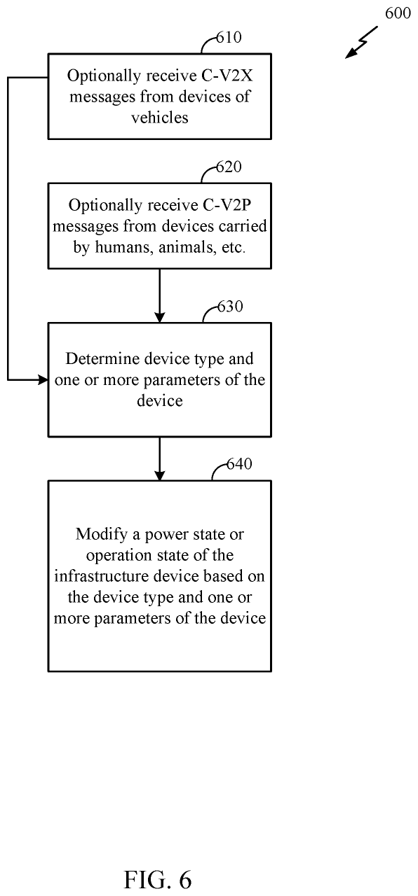

FIG. 5A is an example of a downlink-centric subframe 500A. The downlink-centric subframe 500A may include a control portion 502A. The control portion 502A may exist in the initial or beginning portion of the downlink-centric subframe 500A. The control portion 502A may include various scheduling information or control information corresponding to various portions of the downlink-centric subframe 500A. In some configurations, the control portion 502A may be a physical downlink control channel (PDCCH), as indicated in FIG. 5A. The downlink-centric subframe 500A may also include a downlink data portion 504A. The downlink data portion 504A may sometimes be referred to as the payload of the downlink-centric subframe 500A. The downlink data portion 504A may include the communication resources utilized to communicate downlink data from a scheduling entity (e.g., eNB, base station, Node B, 5G NB, TRP, gNB, etc.) to the subordinate entity, e.g., UE 120. In some configurations, the downlink data portion 504A may be a PDSCH. The downlink-centric subframe 500A may also include a common uplink portion 506A. The common uplink portion 506A may sometimes be referred to as an uplink burst, a common uplink burst, or various other suitable terms. The common uplink portion 506A may include feedback information corresponding to various other portions of the downlink-centric subframe 500A. For example, the common uplink portion 506 may include feedback information corresponding to the control portion 502A. Non-limiting examples of feedback information may include an acknowledgement (ACK) signal, a negative ACK (NACK) signal, a hybrid automatic repeat request (HARD) indicator, or various other suitable types of information. The common uplink portion 506A may include additional or alternative information, such as information pertaining to random access channel (RACH) procedures, scheduling requests (SRs), sounding reference signals (SRS) and various other suitable types of information. As illustrated in FIG. 5A, the end of the downlink data portion 504A may be separated in time from the beginning of the common uplink portion 506A. This time separation may sometimes be referred to as a gap, a guard period, a guard interval, or various other suitable terms. This separation provides time for the switchover from downlink communication (e.g., reception operation by the subordinate entity, e.g., UE 120) to uplink communication (e.g., transmission by the subordinate entity e.g., UE 120). One of ordinary skill in the art will understand, however, that the foregoing is merely one example of a downlink-centric subframe 500A and alternative structures having similar features may exist without deviating from the aspects described herein.

FIG. 5B is an example of an uplink-centric subframe 500B. The uplink-centric subframe 500B may include a control portion 502B. The control portion 502B may exist in the initial or beginning portion of the uplink-centric subframe 500B. The control portion 502B in FIG. 5B may be similar to the control portion 502A described herein with reference to FIG. 5A. The uplink-centric subframe 500B may also include an uplink data portion 504B. The uplink data portion 504B may sometimes be referred to as the payload of the uplink-centric subframe 500B. The uplink portion may refer to the communication resources utilized to communicate uplink data from the subordinate entity, e.g., UE 120 to the scheduling entity 202 (e.g., eNB). In some configurations, the control portion 502B may be a PUSCH. As illustrated in FIG. 5B, the end of the control portion 502B may be separated in time from the beginning of the uplink data portion 504B. This time separation may sometimes be referred to as a gap, guard period, guard interval, or various other suitable terms. This separation provides time for the switchover from downlink communication (e.g., reception operation by the scheduling entity) to uplink communication (e.g., transmission by the scheduling entity). The uplink-centric subframe may also include a common uplink portion 506B. The common uplink portion 506B in FIG. 5B may be similar to the common uplink portion 506A described herein with reference to FIG. 5A. The common uplink portion 506B may additionally or alternatively include information pertaining to channel quality indicator (CQI), SRSs, and various other suitable types of information. One of ordinary skill in the art will understand that the foregoing is merely one example of an uplink-centric subframe 500B and alternative structures having similar features may exist without deviating from the aspects described herein.

In summary, a uplink centric subframe 500B may be used for transmitting uplink data from one or more mobile stations to a base station, and a downlink centric subframe 500A may be used for transmitting downlink data from the base station to the one or more mobile stations. In one aspect, a frame may include both uplink centric subframes 500B and downlink centric subframes 500A. In this example, the ratio of uplink centric subframes 500B to downlink centric subframes 500A in a frame may be dynamically adjusted based on the amount of uplink data and the amount of downlink data that is to be transmitted. For example, if there is more uplink data, then the ratio of uplink centric subframes 500B to downlink centric subframes 500A may be increased. Conversely, if there is more downlink data, then the ratio of uplink centric subframes 500B to downlink centric subframes 500A may be decreased.

A side-communication channel may be used to communicate C-V2X messages to an infrastructure device. The side channel (e.g., V2X communication channel or cellular communications) may be used to communicate a car's location, direction and velocity to an infrastructure device using C-V2X messages. In one case, the information about vehicles in an area may be conveyed from the UE (such as a vehicle) by direct communication with a network entity (e.g., base station, or RSU) or another UE. With the C-V2X mode of operation, there may be two sidelink (or side communication) channels. One is the physical sidelink shared channel (PSSCH), which is used to send and receive data, and the other is the physical sidelink control channel (PSCCH), which is used to send and received control signaling related to the associated PSSCH channel. The infrastructure devices (e.g., traffic lights, street lights, traffic tolls, residential devices such as lights or cameras on a home or in a neighborhood) may listen to such broadcast messages to determine the number of UEs, the speed of the UEs, the direction of the UEs, or any combination thereof.

In one case, the UE may broadcast a signal (beacon, or coded discovery message) on a side-channel. For example, vehicle-to-infrastructure (V2I) communication allows roadside units (RSUs) to monitor traffic, e.g., traffic signals, tolls). RSUs may be radio base stations installed along the side of the road or at intersections (e.g., RSUs may be installed on traffic light poles, lamp poles, or electronic toll collectors).

Currently, the various powered public devices or infrastructure devices such as street lights, traffic lights, etc., may rely on cameras or other sensors in order to vary (e.g., adjust or modify) the brightness (e.g., intensity) or control a power, running, or operating state (power activated, power deactivated, operation mode, default mode, etc). Having such devices operating at a high capacity or full strength may increase electricity costs or may lead to premature device or component failure. Light may also be considered pollution in some cities or other areas, such as rural areas where the economic impact of having the street lights always on at a high intensity may be worse as there is relatively less foot or vehicle traffic.

According to aspects herein, incoming C-V2X messages may be used to control (e.g., modify) the state (e.g., the power state) at an infrastructure device (e.g., street lights, traffic lights, lights in the front yards). Such incoming C-V2X messages may be sent from vehicles, cell phones carried by pedestrians, or other devices (e.g., drones). In one case, street lights may not be powered on or may be powered on at a lower intensity when there are no approaching vehicles (e.g., UEs) or devices equipped with C-V2X in the vicinity. To detect such devices or vehicles, the infrastructure device may monitor and receive C-V2X messages transmitted from the device or vehicles. In some aspects, the infrastructure devices may monitor and receive cellular vehicle-to-person (C-V2P) messages from a cellular device or other devices that a subject (human, animal, etc.) is carrying capable of C-V2X communications.

For instance, a wireless communications system (e.g., wireless communications system 100 of FIG. 1) may allocate time-frequency resources for C-V2X signals, C-V2P signals, C-V2I signals, or any combination thereof. The time-frequency resources may be utilized by vehicles, UEs, infrastructure devices, or other wireless devices in the system for communicating (e.g., transmitting or receiving) C-V2X signals, C-V2P signals, or C-V2I signals. Such signals may include reference signals, control signals, data signals, or the like. In some aspects, the set of time-frequency resources may be periodic such that frequency resources of a frequency band are reserved during given time durations periodically.

Alternatively, a portion of an unlicensed frequency band may be allocated for use by C-V2X, C-V2P, or C-V2I devices and such devices may perform a contention-based procedure (e.g., an LBT procedure) prior to gaining access to a channel of the unlicensed frequency band. Based on the results of the contention-based procedure, a device may either transmit one or more signals using the channel of the unlicensed frequency band over a given TTI (in case of success) or may back off (i.e., refrain from transmitting or continuing to monitor) the channel for a duration of time (in case of failure).

Once a wireless device identifies or determines resources available for C-V2X, C-V2P, or C-V2I signaling, the wireless device (e.g., a UE) may transmit one or more signals via the resources. For example, a wireless device may transmit a C-V2X signal, a user such as a human or animal associated with a wireless device may transmit a C-V2P signal, or an infrastructure device may transmit a C-V2I signal using the resources. In some aspects, a vehicle (e.g., an emergency vehicle) may transmit a C-V2X message after an event is triggered. In an emergency situation, an emergency vehicle may transmit one or more C-V2X messages over the resources when the vehicle is powered on, when one or more designated components (e.g., lights or sirens) are activated, or when a user of the vehicle enables the transmission of C-V2X messages (e.g., a user may identify an emergency and trigger the C-V2X message transmission).

The C-V2X message (or other message) may include information related to the transmitting device, such as the device type (e.g., whether the device is a vehicle, a UE of a human or animal, an infrastructure device, or other wireless device). The C-V2X may also include other information related to the transmitting device such as location information of the transmitting device, velocity information of the transmitting device, directional information of the transmitting device, etc. In some cases, the C-V2X may convey information about the transmitting device implicitly. For instance, a format of the C-V2X message may indicate one or more policies associated with or supported by the transmitting device, where a policy may define a set of parameters available for modification by the transmitting device or, if supported, by the receiving device.

A receiving device (e.g., an infrastructure device) may monitor the set of time-frequency resources allocated for C-V2X, C-V2P, or C-V2I signaling, and in some aspects, may receive a C-V2X, C-V2P, or C-V2I from a wireless device in the system. After receiving the C-V2X, C-V2P, or C-V2I signal, the infrastructure device may determine one or more parameters of the transmitting device such as the device type, location information, velocity information, or directional information. Based on the device type and one or more parameters, the receiving device may modify its state such as an operating state or a power state.

In one case, an emergency vehicle may transmit one or more C-V2X messages, which may be received by an infrastructure device such as a traffic light. After receiving the one or more C-V2X messages, the traffic light may determine one or more parameters of the emergency vehicle such as a velocity of the emergency vehicle, a direction of the emergency vehicle, a location of the emergency vehicle, or the like. Based on the one or more parameters, the traffic light may change its state. For example, the traffic light may determine that the emergency vehicle is traveling toward the traffic light, from the north to the south and the traffic light may change lights in the east-west direction to stop traffic (e.g., lights may be changed to red), while lights in the north-south direction may be change to allow traffic to pass (e.g., lights may be changed to green). In some aspects, neighboring infrastructure devices such as street lights may change their respective states, such as power states. For instance, street lights receiving the one or more C-V2X messages from the emergency vehicle may power on or increase brightness (e.g., increase intensity) as the emergency vehicle approaches and may deactivate or decrease brightness as the emergency vehicles passes or leaved the vicinity (i.e., when the infrastructure device(s) no longer receive C-V2X signals from the transmitting device).

After a given duration of not receiving C-V2X messages from a transmitting device, the receiving device may enable a default state such as a default operating or running state. In one aspect, a traffic light may default to a running state of changing lights based on a timer.

FIG. 6 is a flowchart disclosing a method of modifying the state of device (e.g., a C-V2X, C-V2P, or C-V2I device) based on incoming messages.

Modification of a power state may refer to modifying the intensity of the infrastructure device (e.g., the brightness of a street light or a traffic light). Modification of a running state may refer to whether the infrastructure device is powered on or off (e.g., activated or deactivated) or may refer to whether the infrastructure device is configured for monitoring for incoming C-V2X messages. For example, residential lights such as those attached to a building or a house (e.g., in a yard or driveway) may have a modified running states as being powered on or off and in the off state, the residential lights may monitor for C-V2X messages.

At 610, the infrastructure device monitors for and optionally receives C-V2X messages from vehicles within the range of the infrastructure device (e.g., neighboring UEs associated with vehicles).

At 620, the infrastructure device monitors for and optionally receives C-V2P messages from devices carried by humans, animals, etc. that are within the range of the infrastructure device (e.g., neighboring UEs associated with humans or animals).

For example, at 610 or 620, the infrastructure device may receive an indication of a set of resources to monitor for C-V2X, C-V2P, or C-V2I messages from neighboring devices. The infrastructure device may receive the indication from a node in the system such as a node of the core network, a base station, or other network node. The indication may be received via control signaling (e.g., RRC signaling, MAC control element (MAC-CE)) or other information (e.g., system information, synchronization signal information). In some cases, the infrastructure device may monitor resources of a sidelink channel, such as a sidelink control channel or a sidelink data channel.

At 630, based on C-V2X messages received at 610 or C-V2P messages received at 620, the infrastructure device determines a device type (e.g., vehicle, vehicle type, pedestrian, animal) and one or more parameters of the device(s) that transmitted the received C-V2X or C-V2P messages. Such parameters may include a location of the device, a velocity or speed of the device, a direction in which the device is traveling, etc. In one aspect, the infrastructure device may determine the direction or speed in which the transmitted device (e.g., the vehicle, person, or animal) is moving by analyzing multiple (e.g., successive) C-V2X or C-V2P messages received from the transmitting device.

At 640, based on the device type and one or more parameters, the infrastructure device may modify its state. For example, the infrastructure device may modify a power state such as light intensity. In one case, if the infrastructure device is a street light, the infrastructure device may increase or decrease the brightness of the street light. If the infrastructure device is a traffic light, the infrastructure device may increase or decrease the brightness of the traffic light, change the traffic light color. If the infrastructure device is a residential light, the residential light may be dimmed or brightened. In some aspects, the infrastructure device may modify an operation state such as power on or off. The operation state may include a running state, a default state, an off state, an on state, or any combination thereof.

FIGS. 7A and 7B illustrate a flowchart of a method of modifying a state of a C-V2X infrastructure device based on incoming C-V2X messages. The method of FIGS. 7A and 7B may performed by a device of a wireless communications system, such as an infrastructure device, a UE, a base station, or the like in a wireless communications system that supports C-V2X, C-V2P, or C-V2I communications.

At 710, the infrastructure device operates according to a default state, which may include a default power state, a default operating or running state, or a combination thereof. For example, an infrastructure device such as a street light or traffic light may operate at a low power state as the default power state. In some cases, the infrastructure device may operate in a default operating or running mode such as a traffic light operating according to a timer to change colors of the traffic light(s).

At 720, the infrastructure device monitors for incoming messages such as C-V2X, C-V2P, or C-V2I messages from other devices (e.g., vehicles, UEs carried by a person or animal). For example, the infrastructure device may monitor a set of resources of a sidelink channel allocated for C-V2X, C-V2P, or C-V2I messages. The set of resources may be preconfigured by the wireless communications system or may be indicated (e.g., dynamically or semi-statically) to the infrastructure device (e.g., from a base station or node of the core network). In some cases, multiple messages may be received (e.g., periodically) from at least one neighboring device (e.g., vehicle, person, or animal associated with a UE) within a given time duration. Based on receiving multiple messages, the infrastructure device may determine the location, speed, or direction (e.g., using GPS coordinates contained within the multiple messages) of the at least one neighboring device.

In one case, if the vehicle, person, or animal is approaching an intersection, a traffic light or street light (e.g., the infrastructure device) may modify its power state by increasing the intensity of one or more lights. Alternatively, if the vehicle, person, or animal is moving away, a traffic light or street light (e.g., the infrastructure device) may modify its power state by decreasing the intensity of one or more lights. In some aspects, the velocity of the vehicle, person, or animal may be used to determine when the light intensity is increased or decreased. For example, the infrastructure device may determine when the vehicle, person, or animal will approach (e.g., arrive at) the intersection based on the location and velocity and the infrastructure device may modify its power state or operating state prior to, during, or after the vehicle, person, or animal arrives at or departs from the intersection. Additionally or alternatively, the color of the traffic light may also be modified when a vehicle, person, or animal approaches or departs an intersection.

At 730, the infrastructure devices determines whether there are any incoming messages for a threshold period of time. If the infrastructure device determines that no incoming messages are received for the threshold period of time, the infrastructure device operates according to the default state at 710. For example, a street light may monitor for incoming messages at an intersection associated with a given speed limit for a threshold period of time of about 30 seconds and if no messages are received, may perform a revert action by reverting to a default state. For a street light at an intersection associated with a lower speed limit, the threshold period of time may be greater than 30 seconds such as 45, 60, or 90 seconds, and if no messages are received, may perform a revert action by reverting to a default state. For a street light at an intersection associated with a higher speed limit, the threshold period of time may be less than 30 seconds such as 10, 15, or 20 seconds, and if no messages are received, may perform a revert action by reverting to a default state. That is, the higher the speed limit at an intersection, the shorter the threshold period of time.

At 740, if the infrastructure device receives an incoming message within the threshold period of time, the infrastructure device determines whether there are any associated policies or rules corresponding to the received message. Such a policy or rule may indicate a change in a power state or operating state to the infrastructure. For example, a C-V2X message received from a vehicle may have a policy or rule that is different than a C-V2P message coming from a UE carried by a person. This may be due to the difference in speed with which a vehicle and a person enter and exit an intersection. Based on different policies or rules, the changed state and duration for the infrastructure device to remain in the changed state may vary (e.g., the intensity of a traffic light and the duration the traffic light changes the intensity may be different under different policies or rules).

Other examples of associated policy rules corresponding to the C-V2X messages may include any of the following: 1) A light powers up to full intensity faster and turns off faster when it a vehicle is approaching than when a pedestrian carrying a UE is approaching; 2) The switching of the light intensity to a high intensity or to a low intensity for a given duration is longer when pedestrian carrying a UE is approaching than when a vehicle is approaching; and 3) The policy or rule may enable the infrastructure device to determine how to modify its power state or operating state based on an algorithm using the speed, location, and direction of the device transmitting the incoming messages, as well as other factors such as the type of road (e.g., gravel, paved), where the algorithm generates parameters related to the intensity of light and time duration for switches on and off the light as output.

If there are no associated policies or rules corresponding to the received message(s), the infrastructure device may revert to a default state at 710. If the infrastructure device receives one or more incoming messages associated with a policy or rule, the infrastructure device applies the policy or rule at 750.

At 760, the infrastructure devices determines a threshold period of time for which the policy or rule is to be applied. The threshold period of time for an approaching person or animal associated with a C-V2X equipped device may be longer (e.g., approximately 1 minute) than the threshold period of time for a vehicle equipped with C-V2X (e.g., approximately 20 seconds). The extra time may be taken as the person or animal tends to move slower than a vehicle and in such cases, the infrastructure device may monitor for C-V2X messages less frequently when it is known that the user or animal is expected to move slower. The threshold period of time may vary, such that in some cases may be about 20 seconds for an approaching vehicle on a street, while the threshold period of time may be about 10 seconds for an approaching vehicle on an expressway (e.g., due to generally higher speed limits allowed on expressways). For example, when a vehicle enters an intersection with a traffic light, the traffic light intensity may be increased and remain at a high intensity for a threshold period of time allowing the vehicle to depart the intersection. The traffic light may remain at a high intensity for a longer threshold period of time for a pedestrian entering the intersection allowing the pedestrian to depart the intersection.

If the infrastructure device determines that the state change is to be applied for a threshold period of time, the infrastructure device changes its state and waits for a timeout (e.g., expiration or lapse of the threshold period of time) at 770.

At 780, the infrastructure device determines whether an action is associated with the timeout. Examples of actions associated with timeouts may include monitoring for additional messages. For instance, if the vehicle, person, or animal associated with an incoming message is still near the infrastructure device, the threshold time period may not begin to lapse (e.g., timeout is delayed) before monitoring again for incoming message. If the vehicle, person or human moves away from the infrastructure device, the infrastructure device may monitor for incoming messages after a shorter time duration and the power state (e.g., light intensity) of the infrastructure device may be reduced. If it is determined that an action is associated with the timeout, the infrastructure device performs the action at 785 and then reverts to operating according to a default state at 710.

If there is no action associated with the timeout, or if it is determined that a policy or rule is not to be applied for a threshold period of time, the infrastructure device may determine whether to perform a revert action at 765. A revert action may effectively undo a previously performed action or state change. For example, the high intensity of the traffic light may be changed back to the default state of low intensity. Another example of a revert action may be where a traffic light changes back to its default value of red, after it changed to green to allow vehicles or people to pass through an intersection. In one aspect, as part of a revert action, an infrastructure device may start actively monitoring for incoming messages at a default rate. This may be done because the timing for receiving an incoming message is unknown to the infrastructure device. In another example of a revert action, the infrastructure device may operate lights (e.g., a traffic light) in a state (e.g., according to a timer) when there are no vehicle, people, or animals supported C-V2X, C-V2P, or C-V2I in the vicinity. Yet another example of a revert action may occur at an intersection of a busy (e.g., highly trafficked) road and a less busy (e.g., lower trafficked) road with a traffic signal controlling the flow of traffic. If there is no traffic at the less busy road, then the traffic signal may monitor the busy road less frequently as the busy road is already in an on operation state and other factor(s) that may change the state (e.g., the traffic signal controlling the less busy road) are unlikely to trigger a change of state due to the less busy road having less traffic. In some cases, the infrastructure device may monitor the less busy road more frequently when occasional vehicle or pedestrian traffic is detected.

If there are revert actions to be performed before returning to a default state, the infrastructure device performs the action at 790 and then reverts to a default state at 710. If there are no revert actions to be performed, the infrastructure device operates according to a default state at 710.

Such techniques may allow infrastructure devices (e.g., traffic lights, street lights, tolls) default to a given power state (e.g., a low power state) when vehicles, pedestrians, animals, etc. are not with a given range of the infrastructure device, which may help reduce the operating costs of the infrastructure device. According to some aspects, a traffic light may identify when a vehicle is nearby or within an intersection based on the C-2VX messages transmitted by the vehicle that convey the vehicle location, speed, or direction, and the traffic light may modify or control light intensity before, during, or after the vehicle enters or leaves the intersection.

Although FIGS. 6, 7A, and 7B were discussed with reference to an infrastructure device, it should be understood that a base station, such as base station 801, or a UE, such as wireless communication device 901, may perform any of the operations or actions as described in FIGS. 6, 7A, and 7B.

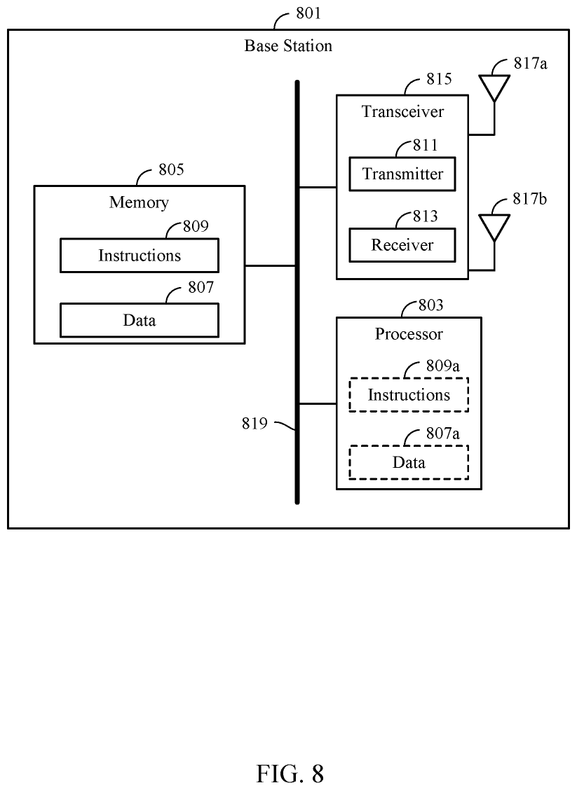

FIG. 8 illustrates certain components that may be included within a base station 801. The base station 801 may be an AP, a NodeB, an evolved NodeB, etc. The base station 801 includes a processor 803. The processor 803 may be a general purpose single or multi-chip microprocessor (e.g., an advanced reduced instruction set (RISC) machine (ARM)), a special purpose microprocessor (e.g., a digital signal processor (DSP)), a microcontroller, a programmable gate array, etc. The processor 803 may be referred to as a central processing unit (CPU). Although just a single processor 803 is shown in the base station 801 of FIG. 8, in an alternative configuration, a combination of processors (e.g., an ARM and a DSP) may be used.

The base station 801 also includes memory 805. The memory 805 may be any electronic component capable of storing electronic information. The memory 805 may be embodied as random-access memory (RAM), read only memory (ROM), magnetic disk storage media, optical storage media, flash memory devices in RAM, on-board memory included with the processor 803, erasable programmable ROM (EPROM) memory, electrically EPROM (EEPROM) memory, registers, and so forth, including combinations thereof.

Data 807 and instructions 809 may be stored in the memory 805. The instructions 809 may be executable by the processor 803 to implement the methods disclosed herein. Executing the instructions 809 may involve the use of the data 807 that is stored in the memory 805. When the processor 803 executes the instructions 809, various portions of the instructions 809a may be loaded onto the processor 803, and various pieces of data 807a may be loaded onto the processor 803.

The base station 801 may also include a transmitter 811 and a receiver 813 to allow transmission and reception of signals to and from the base station 801. The transmitter 811 and receiver 813 may be collectively referred to as a transceiver 815. Multiple antennas 817a, 817b may be electrically coupled to the transceiver 815. The base station 801 may also include (not shown) multiple transmitters, multiple receivers, or multiple transceivers.

The various components of the base station 801 may be coupled together by one or more buses, which may include a power bus, a control signal bus, a status signal bus, a data bus, etc. For the sake of clarity, the various buses are illustrated in FIG. 8 as a bus system 819. The functions described herein in the flowcharts of FIGS. 6, 7A, and 7B may be implemented in hardware, and software executed by a processor such as processor 803 described in FIG. 8.

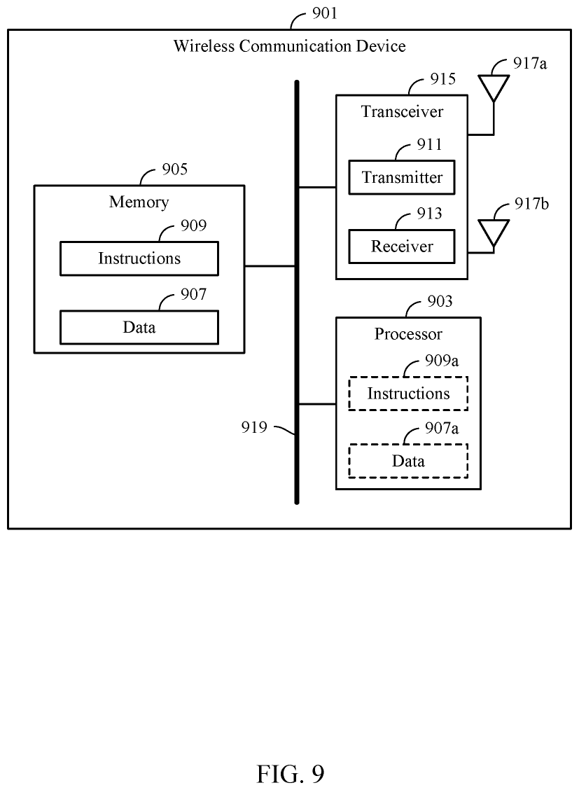

FIG. 9 illustrates certain components that may be included within a wireless communication device 901. The wireless communication device 901 may be an access terminal, a mobile station, a UE (e.g., associated with a vehicle, person, or animal), etc. The wireless communication device 901 includes a processor 903. The processor 903 may be a general-purpose single or multi-chip microprocessor (e.g., an ARM), a special purpose microprocessor (e.g., a DSP), a microcontroller, a programmable gate array, etc. The processor 903 may be referred to as a CPU. Although just a single processor 903 is shown in the wireless communication device 901 of FIG. 9, in an alternative configuration, a combination of processors (e.g., an ARM and a DSP) may be used.

The wireless communication device 901 also includes memory 905. The memory 905 may be any electronic component capable of storing electronic information. The memory 905 may be embodied as RAM, ROM, magnetic disk storage media, optical storage media, flash memory devices in RAM, on-board memory included with the processor 903, EPROM memory, EEPROM memory, registers, and so forth, including combinations thereof.

Data 907 and instructions 909 may be stored in the memory 905. The instructions 909 may be executable by the processor 903 to implement the methods disclosed herein. Executing the instructions 909 may involve the use of the data 907 that is stored in the memory 905. When the processor 903 executes the instructions 909, various portions of the instructions 909a may be loaded onto the processor 903, and various pieces of data 907a may be loaded onto the processor 903.

The wireless communication device 1201 may also include a transmitter 911 and a receiver 913 to allow transmission and reception of signals to and from the wireless communication device 901. The transmitter 911 and receiver 913 may be collectively referred to as a transceiver 915. Multiple antennas 917a, 917b may be electrically coupled to the transceiver 915. The wireless communication device 901 may also include (not shown) multiple transmitters, multiple receivers, or multiple transceivers.

The various components of the wireless communication device 901 may be coupled together by one or more buses, which may include a power bus, a control signal bus, a status signal bus, a data bus, etc. For the sake of clarity, the various buses are illustrated in FIG. 9 as a bus system 919. The functions described herein in the flowcharts of FIGS. 6, 7A, and 7B may be implemented in hardware, and software executed by a processor such as processor 903 described in FIG. 9.

It should be noted that methods herein describe possible implementation, and that the operations and the steps may be rearranged or otherwise modified such that other implementations are possible. In some aspects, aspects from two or more of the methods may be combined. For example, aspects of each of the methods may include steps or aspects of the other methods, or other steps or techniques described herein. Thus, aspects of the disclosure may provide for receiving on transmit and transmitting on receive.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, EEPROM, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11 (wireless fidelity (Wi-Fi)), IEEE 802.16 (WiMAX), IEEE 802.20, Flash-OFDM, etc. UTRA and E-UTRA are part of Universal Mobile Telecommunications System (UMTS). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an AP, a radio transceiver, a NodeB, eNodeB (eNB), Home NodeB, a Home eNodeB, or some other suitable terminology. The geographic coverage area for a base station may be divided into sectors making up a portion of the coverage area. The wireless communications system or systems described herein may include base stations of different types (e.g., macro or small cell base stations).

The UEs described herein may be able to communicate with various types of base stations and network equipment including macro eNBs, small cell eNBs, relay base stations, and the like. There may be overlapping geographic coverage areas for different technologies. In some cases, different coverage areas may be associated with different communication technologies. In some cases, the coverage area for one communication technology may overlap with the coverage area associated with another technology. Different technologies may be associated with the same base station, or with different base stations.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein including, for example, wireless communications system 100 of FIG. 1 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

The various illustrative blocks and modules described in connection with the disclosure herein may be implemented or performed with a general-purpose processor, a DSP, an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label (e.g., a number) by a second label (e.g., a letter) that distinguishes among the similar components. If just the first reference label is used in the specification, the description is applicable to any one of the similar components having the same first reference label irrespective of the second reference label.

What is claimed is:

1. A method for wireless communications implemented by an infrastructure device in a cellular vehicle-to-everything (C-V2X) wireless communications system, comprising:
receiving a C-V2X message from a user equipment (UE) in the C-V2X wireless communications system;
determining a device type of the UE and one or more parameters of the UE based at least in part on the C-V2X message from the UE, wherein the one or more parameters comprises a velocity of the UE, a location of the UE, a direction of the UE at a given time, or any combination thereof; and
modifying a state of the infrastructure device based at least in part on the device type of the UE and the one or more parameters of the UE.

2. The method of claim 1, wherein the modifying the state of the infrastructure device comprises:
modifying a power state or an operating state of the infrastructure device.

3. The method of claim 1, further comprising:
receiving, from the UE, a plurality of C-V2X messages including the C-V2X message within a time duration.

4. The method of claim 1, further comprising:
monitoring for the C-V2X message from the UE and one or more cellular vehicle-to-person (C-V2P) messages or one or more cellular vehicle-to-infrastructure (C-V2I) messages.

5. The method of claim 1, further comprising:
receiving a second C-V2X message from the UE subsequent to receiving the C-V2X message from the UE; and
determining the direction of the UE based at least in part on the C-V2X message and the second C-V2X message.

6. The method of claim 1, wherein the receiving the C-V2X message comprises:
receiving a broadcast beacon carrying the C-V2X message over a set of broadcast resources, wherein the set of broadcast resources are allocated periodically for the broadcast beacon.

7. The method of claim 1, wherein the receiving the C-V2X message comprises:
receiving a coded discovery message indicating the C-V2X message over a sidelink communications channel.

8. The method of claim 1, further comprising:
monitoring for one or more additional C-V2X messages from the UE for a threshold time duration; and
modifying the state of the infrastructure device to a default state based at least in part on an absence of the one or more additional C-V2X messages from the UE during the monitoring for the threshold time duration.

9. The method of claim 1, wherein the modifying the state of the infrastructure device comprises:
applying a policy associated with the C-V2X message to alter a power state of the infrastructure device.

10. The method of claim 9, wherein the policy is applied during a timeout period for the infrastructure device.

11. The method of claim 10, further comprising:
performing at least one action during the timeout period based at least in part on the policy.

12. The method of claim 11, further comprising:
performing at least one revert action after performing the at least one action, wherein the revert action comprises modifying a color or an intensity of a traffic light.

13. The method of claim 1, wherein the infrastructure device comprises a street light, a traffic light, a residential light, or any combination thereof.

14. The method of claim 1, wherein the UE is located on or within a vehicle of the C-V2X wireless communications system.

15. An apparatus for wireless communications implemented by an infrastructure device in a cellular vehicle-to-everything (C-V2X) wireless communications system, comprising:
a processor,
memory coupled with the processor; and
instructions stored in the memory and executable by the processor to cause the apparatus to:
receive a C-V2X message from a user equipment (UE) in the C-V2X wireless communications system;
determine a device type of the UE and one or more parameters of the UE based at least in part on the C-V2X message from the UE, wherein the one or more parameters comprises a velocity of the UE, a location of the UE, a direction of the UE at a given time, or any combination thereof; and
modify a state of the infrastructure device based at least in part on the device type of the UE and the one or more parameters of the UE.

16. The apparatus of claim 15, wherein the instructions are further executable by the processor to cause the apparatus to:
modify a power state or an operating state of the infrastructure device.

17. The apparatus of claim 15, wherein the instructions are further executable by the processor to cause the apparatus to:
receive, from the UE, a plurality of C-V2X messages including the C-V2X message within a time duration.

18. The apparatus of claim 15, wherein the instructions are further executable by the processor to cause the apparatus to:
monitor for the C-V2X message from the UE and one or more cellular vehicle-to-person (C-V2P) messages or one or more cellular vehicle-to-infrastructure (C-V2I) messages.

19. The apparatus of claim 15, wherein the instructions are further executable by the processor to cause the apparatus to:
receive a second C-V2X message from the UE subsequent to receiving the C-V2X message from the UE; and
determine the direction of the UE based at least in part on the C-V2X message and the second C-V2X message.

20. The apparatus of claim 15, wherein the instructions are further executable by the processor to cause the apparatus to:
receive a broadcast beacon carrying the C-V2X message over a set of broadcast resources, wherein the set of broadcast resources are allocated periodically for the broadcast beacon.

21. The apparatus of claim 15, wherein the instructions are further executable by the processor to cause the apparatus to:
receive a coded discovery message indicating the C-V2X message over a sidelink communications channel.

22. The apparatus of claim 15, wherein the instructions are further executable by the processor to cause the apparatus to:
monitor for one or more additional C-V2X messages from the UE for a threshold time duration; and
modify the state of the infrastructure device to a default state based at least in part on an absence of the one or more additional C-V2X messages from the UE during the monitoring for the threshold time duration.

23. The apparatus of claim 15, wherein the instructions are further executable by the processor to cause the apparatus to:
apply a policy associated with the C-V2X message to alter a power state of the infrastructure device.

24. The apparatus of claim 23, wherein the policy is applied during a timeout period for the infrastructure device.

25. The apparatus of claim 24, wherein the instructions are further executable by the processor to cause the apparatus to:
perform at least one action during the timeout period based at least in part on the policy.

26. The apparatus of claim 25, wherein the instructions are further executable by the processor to cause the apparatus to:
perform at least one revert action after performing the at least one action, wherein the revert action comprises modifying a color or an intensity of a traffic light.

27. The apparatus of claim 15, wherein the infrastructure device comprises a street light, a traffic light, a residential light, or any combination thereof.

28. The apparatus of claim 15, wherein the UE is located on or within a vehicle of the C-V2X wireless communications system.

29. An apparatus for wireless communications implemented by an infrastructure device in a cellular vehicle-to-everything (C-V2X) wireless communications system, comprising:
means for receiving a C-V2X message from a user equipment (UE) in the C-V2X wireless communications system;
means for determining a device type of the UE and one or more parameters of the UE based at least in part on the C-V2X message from the UE, wherein the one or more parameters comprises a velocity of the UE, a location of the UE, a direction of the UE at a given time, or any combination thereof; and
means for modifying a state of the infrastructure device based at least in part on the device type of the UE and the one or more parameters of the UE.

30. A non-transitory computer-readable medium storing code for wireless communications implemented by an infrastructure device in a cellular vehicle-to-everything (C-V2X) wireless communications system, the code comprising instructions executable by a processor to:
receive a C-V2X message from a user equipment (UE) in the C-V2X wireless communications system;
determine a device type of the UE and one or more parameters of the UE based at least in part on the C-V2X message from the UE, wherein the one or more parameters comprises a velocity of the UE, a location of the UE, a direction of the UE at a given time, or any combination thereof; and
modify a state of the infrastructure device based at least in part on the device type of the UE and the one or more parameters of the UE.
